(19) United States
(12) Patent Application Publication
(10) Pub. No.: US 2017/0103096 A1
(43) Pub. Date: Apr. 13, 2017

(54) ENHANCING TABLES AND SQL INTERACTION WITH QUEUE SEMANTICS

(71) Applicant: TERADATA US, INC., Dayton, OH (US)

(72) Inventors: Jason S. Chen, Rancho Palos Verdes, CA (US); Bhashyam Ramesh, Secunderabad (IN)

(73) Assignee: TERADATA US, INC., Dayton, OH (US)

(21) Appl. No.: 14/094,190

(22) Filed: Dec. 2, 2013

(51) Int. Cl. G06F 17/30

(52) U.S. Cl. CPC G06F 17/30339; G06F 17/30477

(57) ABSTRACT

A database management system returns data from a database table in response to a database query. It does so by assessing whether the database table has any rows of data. When there are no rows of data in the table, execution of the query is halted until data is placed in the database table and then the data that placed in the database table is returned in response to the query.

### CROSS-REFERENCE TO RELATED APPLICATIONS

This application is a divisional application of U.S. patent application Ser. No. 11/238,937; entitled “ENHANCING TABLES AND SQL INTERACTION WITH QUEUE SEMANTICS” by Jason Chen and Bhashyam Ramesh; filed on Sep. 29, 2005.

### TECHNICAL FIELD

The present invention relates to Enterprise Data Warehouses and Relational Database Management Systems used to support real-time decision management.

### BACKGROUND

Enterprise data warehouse (EDW) systems have traditionally been used for decision support by enabling business entities to view some aspect of their businesses in real-time and plan tactical or strategic moves aimed at improving operations. Businesses increasingly are trying to push the decision support capabilities of EDW systems to real-time, allowing for decisions on business operations to be made quickly in response to certain events. In many cases, real-time events occur in some time-ordered manner or priority, the order of which the businesses would like to preserve and react to accordingly. Traditional EDW systems, however, do not easily lend themselves to these sort of time-ordered operations, and attempts at making them do so have proven difficult.

### SUMMARY

In general, according to one embodiment, this invention involves a method for use in delivering data from a database table in response to a query. The method includes accessing an ordered list that indicates an order of retrieval for each of one or more rows in the database table and returning the row that is first in the order.

In general, according to one embodiment, this invention involves a method for use in delivering data from a database table in response to a query. The method includes assessing whether the database table has any rows of data. When there are no rows of data in the table, halting execution of the query until data is placed in the database table and then returning the data that was placed in the database table.

In general, according to one embodiment, this invention involves a system for use in delivering data from a database table in response to a query. The system provided by embodiments of the present invention comprises: a database that includes one table; one or more data-storage facilities that together store the database; and a database-management component coupled to the database and configured to access an ordered list that indicates an order of retrieval for each of one or more rows in the database table and returns the row that is first in the order.

In general, according to one embodiment, this invention involves a system for use in storing data in a database table. The system provided by embodiments of the present invention comprises: a database that includes one table; one or more data-storage facilities that together store the database; and a database-management component coupled to the database and configured to store data in one or more rows in the database table and create an ordered list that indicates an order of retrieval for the one or more rows.

In general, according to one embodiment, this invention involves a system for use in delivering data from a database table in response to a query. The system provided by embodiments of the present invention comprises: a database that includes one table; one or more data-storage facilities that together store the database; and a database-management component coupled to the database and configured to assess whether the database table has any rows of data. When there are no rows of data in the table, halting executing of the query until data is placed in the database table and then returning the data that was placed in the database table.

### BRIEF DESCRIPTION OF THE DRAWINGS

FIGS. 1A and 1B are block diagrams of a massively parallel processor (MPP) system.

FIG. 2 is a block diagram of a database comprising a queue table and a relational database table.

FIG. 3 is a flow chart that illustrates execution of a query on a queue table.

FIG. 4 is a flow chart that illustrates execution of a “select and consume” command on a queue table.

FIGS. 5A and 5B are flow charts that illustrate insertion of data into a queue table.

### DETAILED DESCRIPTION

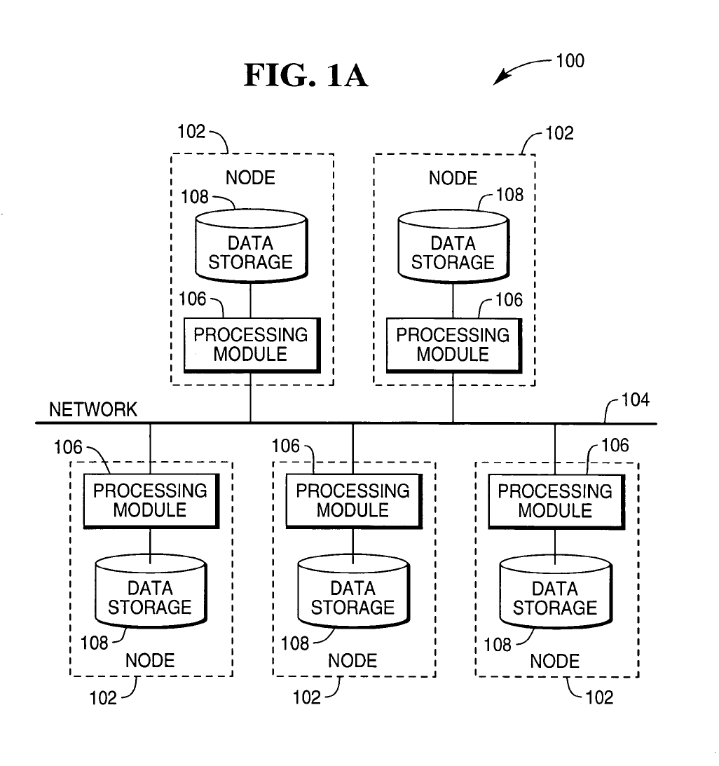

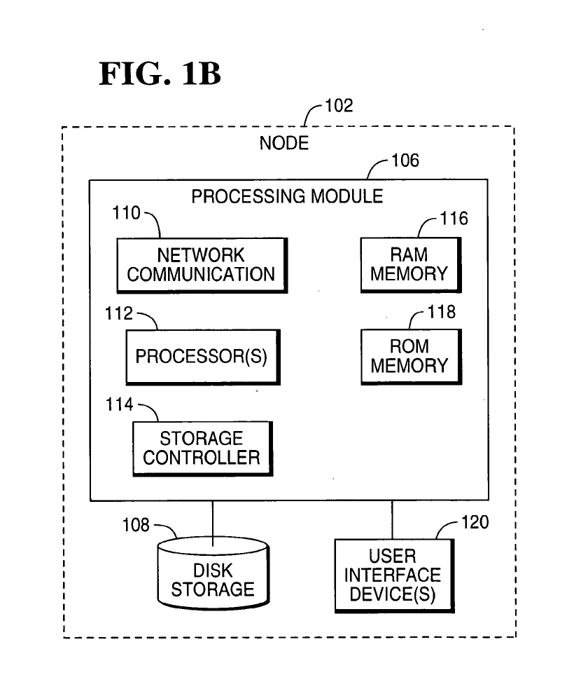

FIGS. 1A and 1B are block diagrams that illustrate an exemplary computer hardware environment that is often used to implement an Enterprise Data Warehouse (EDW) as a Relational Database Management System (RDBMS). The computer hardware environment shown here is a massively parallel processing (MPP) computer system 100 that includes one or more nodes 102 interconnected by a network 104. Within each of the nodes 102 is a processing module 106, which typically includes: one or more physical processors 112; random access memory (RAM) 116; read-only memory (ROM) 118; network communications hardware 110; and other components. Each of the physical processors 112 may also include multiple core processors. In some systems, one or more data storage units (DSUs) 108 are attached to the processing module 106 through a storage controller 114. Typically, at least one of the nodes 102 also includes user interface components such as a monitor, a keyboard, and a mouse 120. A database administrator (DBA) is able to manage the RDBMS through the user interface components 120 in one of the nodes or by communicating over the network 104 to one of the nodes 102 having a user interface 120.

Each of the nodes 102 executes one or more computer programs, such as an operating system, Data Mining Applications performing data mining operations, Real-time Data Management (RTDM) Applications for performing operations on the data, Client Database Applications interacting with the database, and/or a Relational Database Management System (RDBMS) for managing a relational database stored across one or more of the DSUs. In some embodiments, a computer system having only a single node manages all or some subset of the computer programs.

Those skilled in the art will recognize that the exemplary environment illustrated in FIGS. 1A and 1B are not intended to limit the present invention. Indeed, those skilled in the art will recognize that other alternative hardware environments may be used without departing from the scope of the present invention. In addition, it should be understood that the present invention may also apply to other computer programs than those disclosed here.

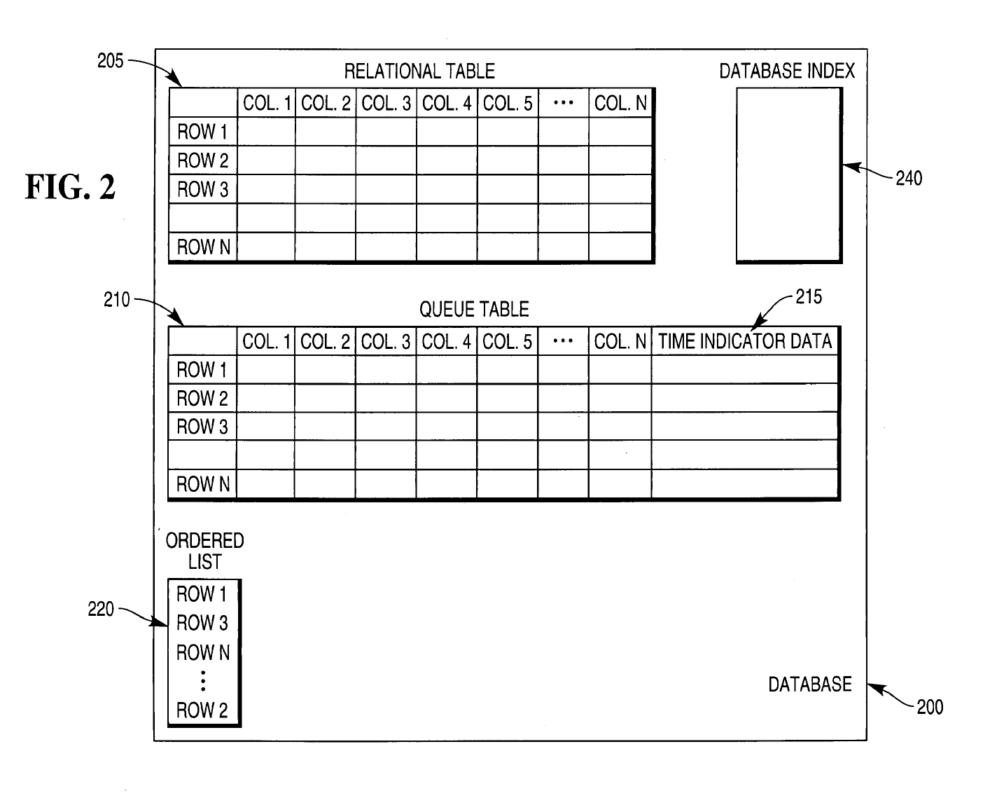

FIG. 2 shows the structure of a relational database 200 which is organized into one or more relational tables 205 that store data in an organized fashion, typically according to a logical data model (LDM) created especially for the type of data being stored. Client computer systems access the data stored in the database tables 205 by submitting queries to the RDBMS in some database query language such as the Structured Query Language (SQL) put forth by the American National Standards Institute (ANSI). One or more indexes 240 are created within the database to summarize the data stored in the database and thus to reduce the time required to identify and access the data that is responsive to any given query. The index 240 typically contains information about the data stored in each row of a table, information which allows the database to execute database queries without accessing and examining every row in the table.

In addition to traditional relational tables, the database 200 also includes one or more tables, known as queue tables 210, that provide enhanced support for real-time decision making in an EDW system. Each of the queue tables 210 is a relational table that has non-traditional “queue like” properties. In particular, each of the queue tables 210 is created and managed in a manner that provides for the preservation of order amongst data placed in the table. This preservation of order typically appears as a preservation of some time related order (e.g., the time order in which the data is placed in the queue table or comes into existence at some external source) or as the preservation of some priority-based order (e.g., higher priority data is distinguished from lower priority data). In general, the queue tables typically use some characteristic of the data they store—be it an intrinsic characteristic of the data created with the data itself or an extrinsic characteristic added to the data at some point—to indicate an order of retrieval for returning the rows of data that make up the tables.

One way that the database, through the queue tables 210, preserves the order of data is through the use of one or more index type structures known as ordered lists 220. Each of the ordered lists 220 in the database maintains, for a corresponding queue table 210, an order of retrieval for the rows stored in that queue table. Unlike a standard database index 240, which can not anticipate which data will be requested or the order in which it will be returned, the ordered lists 220 are created precisely to specify which rows of data are returned in response to individual queries.

The criteria used in any one of the ordered lists 220 to govern the retrieval order for rows of data stored in the corresponding queue table 210 are independent of the nature of the database system in which the queue tables are implemented and are often chosen by the DBA. For example, in some systems, the retrieval order in an ordered list relies on time based information, such as a timestamp indicating when each row was created in the corresponding queue table. The database may or may not store the time based information with the corresponding rows of data. This time based information, when it is stored with the corresponding data, is typically stored in a time indicator data column 215 in the corresponding queue table 210. In some embodiments however, the time based information, if stored at all, is stored outside of the queue table. For example, in some of these embodiments, the time based information is stored as part of the ordered list that corresponds to the queue table. Also, in some embodiments, the time based information is hidden and is not assessable through database queries, while in other embodiments the time based information is accessible through database queries.

In other embodiments, the retrieval order preserved by the ordered list is based on an occurrence of some event other than the time at which the data was stored in the corresponding queue table. In these embodiments, the time at which the event occurred is typically supplied with the data.

In still other embodiments, retrieval order is based on priority ratings assigned to the rows of data stored in the queue table. In some cases, the priority ratings are provided to the database along with the data and, in others, priority ratings are calculated within the database by applying an algorithm to the data stored in the queue table.

Queue tables like those described above carry several advantages beyond their ability to preserve order among data. These advantages include: 1) the ability to suspend execution of a database query when no data is available and then resume execution of the query and return the requested data when the data becomes available; 2) the ability to return only a single row of data in response to a query, even when multiple rows satisfy the query; and 3) the ability to execute “select and consume” queries that lead to the return of a row of data followed by deletion of the data from the queue table.

In regard to the first of these advantages, when the database receives a traditional database query, the database either returns the requested data or upon failing to return data, indicates that no data is available and ends the query. In a real-time environment, failing to return data wastes valuable computer and database resources, because it forces the reissuance of the query, perhaps more than once, until data is available. Through the use of queue tables, on the other hand, the database is able to suspend execution of a query when no data is available and resume execution of the query once the data becomes available. Suspending and resuming queries in this manner reduces the consumption of computer and database resources used in processing queries and reduces the delays traditionally associated with retrieving real-time data from the database.

The second of the advantages listed above is the ability of the database to return only a single row of data from a database table in response to a query, even when multiple rows of data might satisfy the query. In a traditional database system, a single row of data can be returned only if the query is sufficiently complex and has decided to target only that row. Quiet often, such a query is not even possible. In a database system implementing queue tables however, the DBA can set the system to return only one row from a queue table in response to any query. Returning only a single row of data greatly reduces the complexity of database queries and minimizes the impact on the resources required to execute the queries when only small amounts of data are needed at a time.

The use of queue tables also allows the database to execute “select and consume” commands. These commands provide a simple mechanism for retrieving a row of data from a queue table and then removing or deleting the returned row from the queue table. In general, the “select and consume command” is performed as an indivisible command that is not and in fact can not be interrupted during execution. In a traditional database system, data is locked at the SQL command level to prevent the execution of other queries attempting to retrieve the same data before that data can be deleted from the table. The structure of the queue table allows for easy execution of a “select and consume” command in the database system.

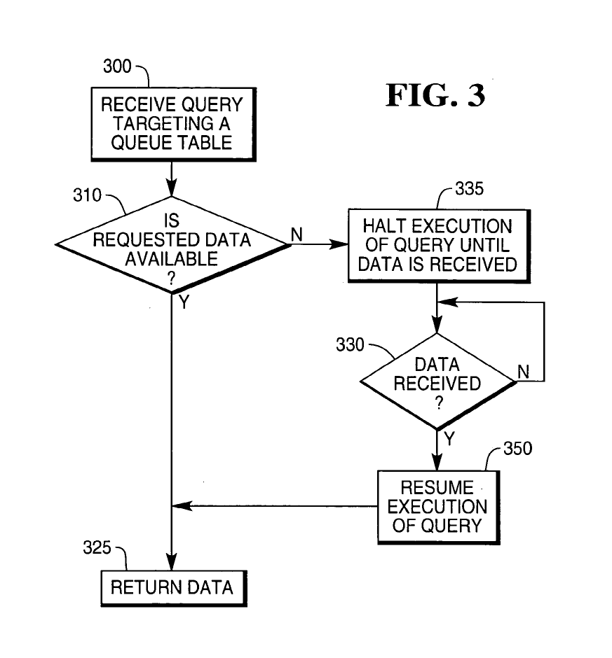

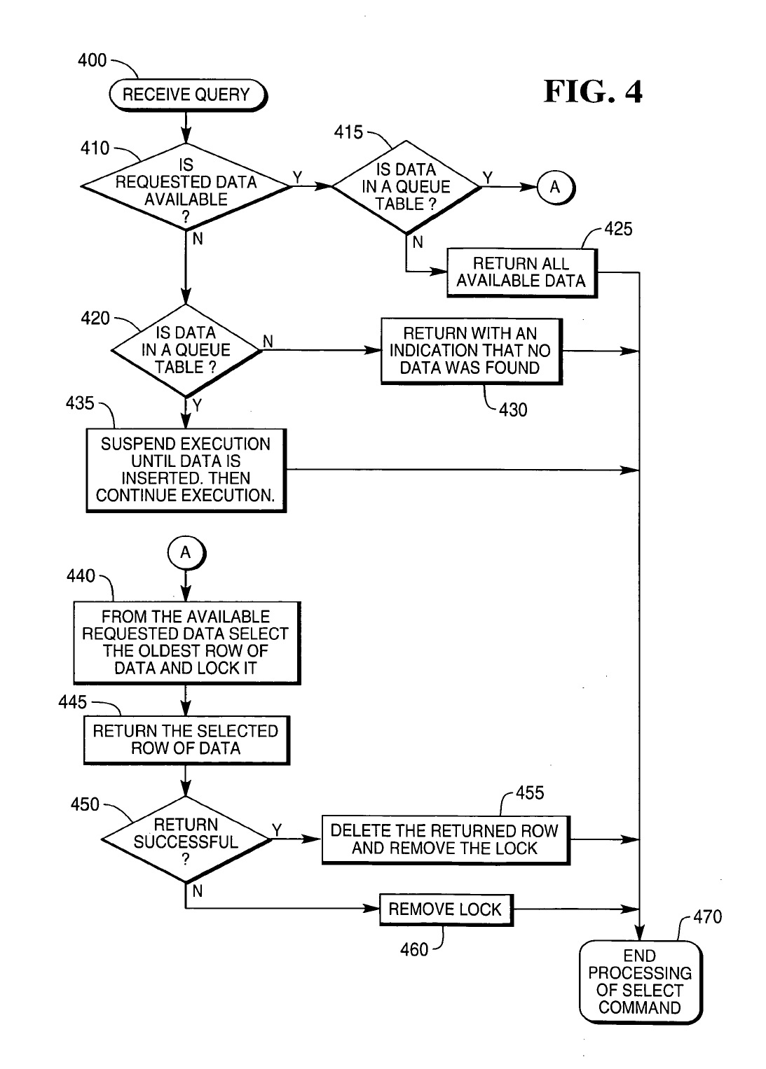

FIGS. 3 and 4 both show examples for flow of operations in the database when processing queries that target queue tables. In general, the database processes incoming queries differently when a queue table is targeted than it does when a tradition relational table is targeted.

FIG. 3 illustrates a database operation where suspension and resumption of a query is called for. Upon receiving a query that targets a queue table (step 300), the database assesses whether data is available in the table (step 310). If data is available, the database returns at least some portion of the requested data (step 320). If no data is available in the queue table, the database halts execution of the query command (step 330) until it receives an indication that data responsive to the query has been placed into the table (step 340). Upon receiving the indication, the database resumes the query (step 350) and returns at least some portion of the data requested (step 320).

In some systems, when the database system suspends a query, the application that issued the query also suspends execution. In some of these systems, the application starts a timer before issuing the query. If the timer expires before the application has received a response to the query, the application (or some part of the application) resumes execution and the application decides whether to: 1) abort the query altogether; 2) process other work while continuing to await for a response; or 3) set another timer and continue to wait for a response to the query.

FIG. 4 shows an example of database operations when queue tables are present in the system. Upon receiving a database query, (step 400), the database assesses whether data is available in the table or tables (step 410). If data is available, the database assesses the type of table targeted by the query (step 415). If a queue table is not involved in the query, the database returns at least some portion of the requested data (step 425) and the database terminates the processing of the query (step 470). If a queue table is involved in the query, the database identifies and locks the next row in the queue table (step 440) and then returns at least some portion of the requested data (step 445). The database then assesses whether the requested data was returned successfully (step 450). If the data was returned successfully, the locked row is deleted from the queue table and the lock is removed (step 455), and then the database terminates the processing of the query (step 470). If the data was not returned successfully, the data remains in the queue table but the lock is removed (step 460) and the database terminates the processing of the query (step 470).

Returning to step 410, if no data is available, the database assesses the type of table targeted by the query (step 420). If a queue table is not involved in the query, the database will return a token indicating that no data was available and then terminate the processing of the query (step 470). If a queue table is involved in the query, the database will suspend execution of the query until the requested data is received (step 435) and then terminate the processing of the query (step 470).

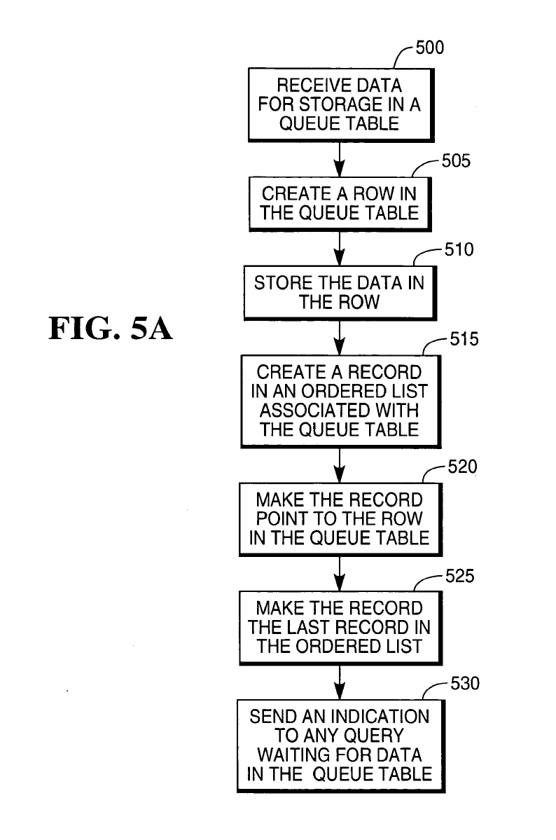

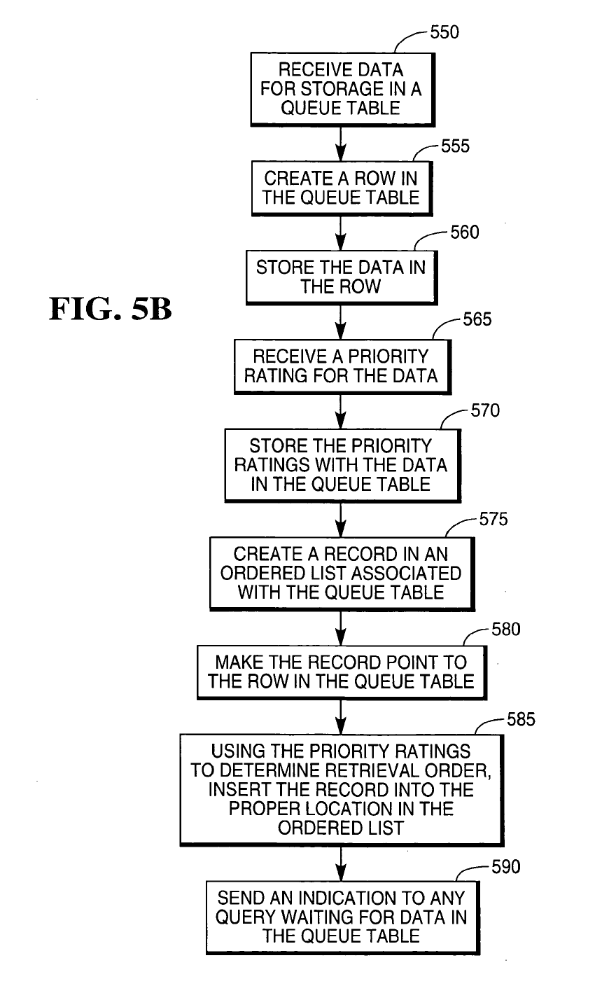

FIGS. 5A and 5B both show examples for inserting data into a queue table. In general, when data is inserted into a queue table, the database performs the traditional steps of inserting the data into the queue table and then performs an additional step of managing an ordered list that is associated with the queue table. An ordered list is a database structure associated with a queue table and maintained by the database. The ordered list indicates the order of retrieval for the rows of data stored in the queue table. In some systems, the ordered list is a simple linked list of pointers to the rows in the queue table. The list is linked together in the order in which the rows are to be retrieved. Any of several different algorithms can be selected to govern the order of retrieval when the queue table that the ordered list is associated with is created. Among the possible algorithms are: 1) returning the oldest data stored in the queue table, where calculating the age of the data is based on when the data was inserted into the queue table; 2) returning the oldest data stored in the queue table, where calculating the age of the data is based on a date provided with the data; and 3) returning the data having the highest priority rating, where the priority rating is based on a information provided with the data (this may involve a calculation that was provided when the algorithm was selected). In some systems, the DBA selects default settings for all queue tables which include the order of retrieval.

FIG. 5A illustrates an operation for inserting data into a queue table and updating the ordered list associated with the queue table. In this example, the order of retrieval is based on when the data was inserted into the queue table e.g., the row of data that has been stored in the queue table for the longest period of time is first in the order of retrieval.

Upon receiving data for storage in a queue table (step 500), the database creates a row in the queue table (step 505) and stores the data in that row (step 510). A record is then created in an ordered list associated with the queue table (step 515) and a pointer to the row in the queue table is stored in the record (step 520). The record is added to the ordered list so that it is last in the ordered list (step 525). (It is possible that the record can be both last and first in the ordered list if the queue table has only one row of data.) The record is last in the ordered list because the data that it points to is the most recently stored data in the queue table. The record remains last in the ordered list until another record is added to the ordered list. As additional data is inserted into the queue table, the data associated with the record ages and becomes decreasingly recent. At some point, this data becomes the oldest data in the queue table and therefore will be first in the ordered list. Once the data is stored and the ordered list updated, an indication is sent to any query waiting for data to be inserted into this queue table (step 530). The indication causes the waiting or suspended query to resume execution.

FIG. 5B illustrates an operation for inserting data into a queue table and updating the ordered list associated with the queue table. In this case, the order of retrieval is based on a priority rating provided with the data. Upon receiving data for storage in a queue table (step 550), the database creates a row in the queue table (step 555) and stores the data in that row (step 560). The priority rating is received (step 565) and stored with the data in the queue table (step 570). In some systems, the priority rating is stored separately from the data. In still other systems, the priority rating is stored in the ordered list. A record is then created in an ordered list associated with the queue table (step 575) and a pointer to the row in the queue table is stored in the record (step 580). The record is inserted into the ordered list based on the priority ratings (step 585). Once the data and priority ratings are stored and the ordered list is updated, an indication is sent to any query waiting for data to be inserted into this queue table (step 590). The indication causes the waiting or suspended query to resume execution.

In some systems, a query command that targets a queue table will include an SQL “where” clause that places restrictions on the data to be returned. When a query of this type is received, the database examines the data in the queue table in the order specified by the ordered list associated with the queue table and returns at least a portion of the data from the first row found that satisfies the restrictions contained in the query. The row may not be the first row listed in the ordered list, but it will be the row closest to the first row in the ordered list that satisfies the query. If no data is found, the execution of the query is suspended until data satisfying the query is inserted into the queue table. In still other systems, when a query containing a “where” clause is received, the database uses one or more database indexes along with the ordered list to reduce the time needed to search for data in the queue table.

While the invention has been described with respect to a limited number of embodiments, those skilled in the art will appreciate that numerous modifications and variations of the invention exist. It is intended that the appended claims cover all such modifications and variations as fall within the true spirit and scope of the invention.

What is claimed is:

1. A computer-implemented method for use in returning data from a database table in response to a query, the method comprising:
assessing whether the database table has any rows of data; and
when the database table has no rows of data:
halting execution of the query until data is placed in the database table; and thereafter
returning the data that was placed in the database table.

2. The method of claim 1, where returning the data further comprises resuming execution of the query.

3. The method of claim 1, further comprising, deleting the data from the database table after returning it.

4. A relational database management system for use in delivering data from a database table in response to a query, the system comprising:
one or more data-storage facilities that together store a database; and
a database-management component configured to:
assess whether the database table has any rows; and
when the database table has no rows:
halt execution of the query until a row is created in the database table; and thereafter
return data from the row.

5. The system of claim 4, where the database-management component is also configured to resume execution of the query after the row is created in the database table.

6. The system of claim 4, where the database-management component is further configured to delete the row from the database table after it is returned the data from that row.
